(19) United States
(12) Patent Application Publication
(10) Pub. No.: US 2011/0215499 A1
(43) Pub. Date: Sep. 8, 2011

(54) EXTRUSION NOZZLE FOR POLYMERS

(75) Inventors: Martin Luedeke, Krefeld (DE); Rainer Mellis, Baytown, TX (US); Jens Hepperle, Koeln (DE); Reiner Rudolf, Langenfeld (DE)

(73) Assignee: BAYER MATERIALSCIENCE AG, Leverkusen (DE)

(21) Appl. No.: 13/126,775

(22) PCT Filed: Oct. 21, 2009
(86) PCT No.: PCT/EP2009/007527

§ 371 Date: Apr. 29, 2011

(30) Foreign Application Priority Data
Oct. 29, 2008 (DE) 10 2008 053 799.3

(51) Int. Cl. B29B 9/06; B29C 47/00; B29C 47/88; B29C 70/02; B29C 71/02

(52) U.S. Cl. 264/143; 425/376.1; 264/319; 264/257

(57) ABSTRACT

The invention relates to an improved die for the extrusion of melt strands of viscoelastic masses, and in particular to polymers and mixtures of polymers with other substances (such as solids, liquids or other polymers), where the use thereof avoids the formation of deposits in the region of the die.

The present invention relates to an improved die for the extrusion of melt strands of viscoelastic masses, and in particular to polymers and mixtures of polymers with other substances (such as solids, liquids, gases or other polymers or other polymer mixtures), where the use thereof avoids the formation of deposits in the region of the die.

In the known processes of extrusion of melt strands of polymers and polymer preparations, in particular when cylindrical dies are used, melt films or melt deposits are observed to form in the region of said cylindrically shaped dies. Over the course of time, the extent of this effect increases, depending on the nature and constitution of the material processed. Increasing formation of such deposits creates the risk that the emerging melt strand will entrain these deposits in the region of the die and that they remain on the surface of the strand and thus cause undesired contamination of the polymers during subsequent pelletization or further treatment of the melt strand. Polycarbonates and glass-fiber-reinforced polyesters and glass-fiber-reinforced polyamides have a particularly marked tendency toward such die deposits; they sometimes do not appear until many hours of processing time have passed. The pellets contaminated by the contamination impair the quality of the moldings produced therefrom in the injection-molding process or in the extrusion process. This applies in particular to the optical properties of the moldings, e.g. of optical data carriers (CDs, DVDs), optical conductors, panels, including diffuser panels, and sheets and foils, etc. In order to avoid such contamination, when the traditional cylindrical dies are used, it is necessary to interrupt the extrusion or compounding process at the appropriate time prior to formation of any relatively large amounts of die deposits, and to clean or replace the dies or the die plate. This type of procedure impairs the production process because it uses additional time-consuming operations, requires additional energy (use of burn-out cleaning methods) and produces product waste during the die change or the cleaning process. In the case of some types of apparatus which are substantially enclosed during the production process and are difficult to access, an example being strand devolatilizers, the requirement to open the apparatus, and also other reasons known to the person skilled in the art, mean that it is extremely inconvenient to interrupt production.

It was therefore an object to provide a die which can prolong what is known as the service time of the die, this being defined as the time by which the corresponding apparatus can be operated without impairment of quality (e.g. caused by contamination) in the resultant melt strands. The aim is therefore to prolong the service time of the die, by markedly reducing the tendency toward formation of, or indeed entirely avoiding, deposits on the dies of the invention. The effect of this on the extent of the cleaning processes otherwise required on the dies is between a marked reduction and complete elimination. Another result is substantial avoidance of any risk of contamination or quality-impairment of the polymers caused by die deposits.

U.S. Pat. No. 5,458,836 discloses attempts to solve the problem of die deposits during the extrusion procedure by using specific designs of extrusion dies for polymer melts. To this end, dies are used which have respectively cylindrical inflow and outflow channels, where these differ from one another in their diameter and widen in the transition region of the two channels in the interior of the die. These are not therefore convergent or divergent channels. Unlike the die of the invention, the inflow channel is always longer than, or at least as long as, the outflow channel. The patent specification does not give any indication of behavior in relation to formation of die deposits during extrusion processes over a number of hours.

WO 2004/098858 and WO 2004/098859 describe dies for the extrusion of viscoelastic melts; although these have convergent-divergent widening of inflow channel and outflow channel, the inflow channel in these, unlike in the die of the invention, is always longer than, or at least as long as, the outflow channel of the die. WO 2004/098859 also describes the option of specific widening of the outflow channel at the die exit in the form of rounding-off corresponding to a circular arc (viewed in cross section). The disclosures do not give any kind of indication of possible die deposits or the relationship of these to the design of the dies.

The other data provided by WO 2004/080692, in addition to the above information, relates only to the arrangement of the die and to the nature of the inner surface of the flow channels.

Surprisingly, it has been found that dies with a specific geometry differ from the cited prior art in being suitable for achieving the object of the invention, via a change in the ratio of convergent melt-inflow region of the flow channel to divergent melt-outflow region of the flow channel of the die.

Surprisingly, it has also been found that cylindrical dies with conically convergent inflow channel and conically divergent outflow channel in conjunction with a long melt-outflow region with respect to the melt-inflow region have substantially better suitability for the avoidance of die deposits than dies which have comparable geometry but have a shorter melt-outflow region. Said dies of the invention avoid die deposits even over prolonged extrusion times. There are also other geometric parameters relating to the die which distinguish the die from the prior art and are concomitant, alongside said length ratios of outflow region to inflow region of the flow channel of the die, in providing the avoidance of die deposits during the procedure of extrusion of the polymer melts. Among these are in particular the aperture angles of the inflow and outflow regions of the flow channel and the curvature radii of these.

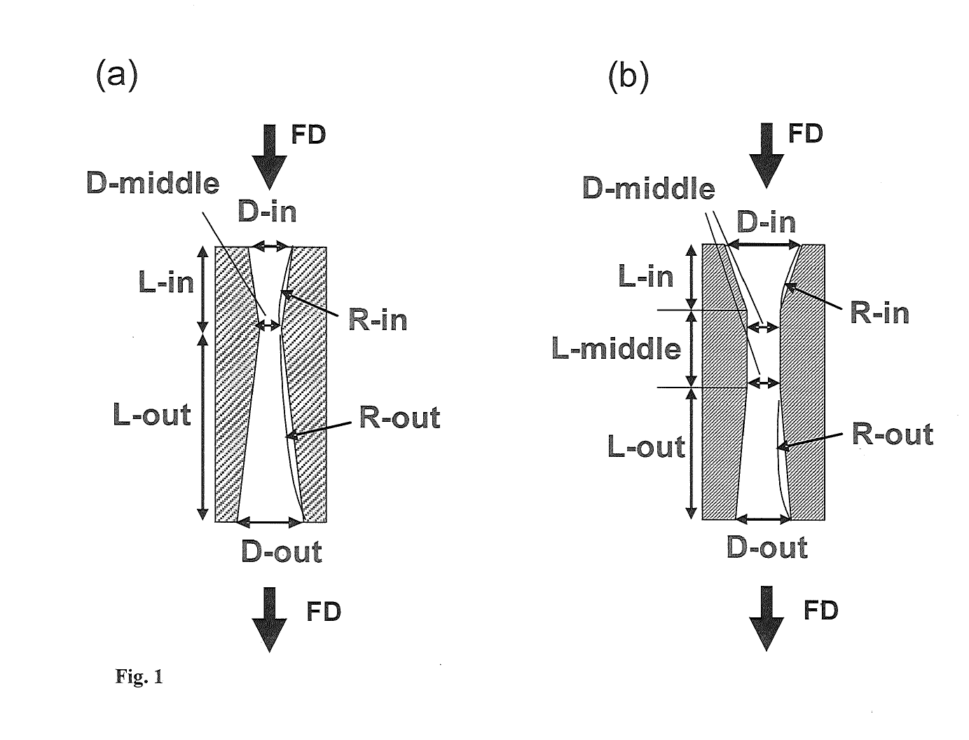

The invention therefore provides a die for the melt-extrusion of viscoelastic masses, in particular of polymers and mixtures of polymers with other substances (such as solids, liquids, gases or other polymers or other polymer mixtures), characterized in that the flow channel thereof has a divergent melt-outflow region, the length L-out of which is greater than the length L-in of the convergent melt-inflow region and the ratio L-out/L-in is from 1.1 to 15, preferably from 2 to 10, particularly preferably from 4 to 8. The parameters are explained in more detail by using FIG. 1. “FD” here means the direction of flow (flow direction).

Use of the die of the invention permits avoidance of the formation of deposits in the region of the die. This prolongs the service time of the die during the extrusion of the polymer strands and avoids contamination caused by entrainment of die deposits on polymer-melt strands.

L-out is preferably from 2 mm to 100 mm, particularly preferably from 5 mm to 60 mm, very particularly preferably from 10 mm to 50 mm. D-out is preferably from 0.2 mm to 15 mm, particularly preferably from 0.5 mm to 10 mm, very particularly preferably from 1 mm to 9 mm L-in is preferably from 0.13 mm to 200 mm, D-in being from 0.4 mm to 30 mm and D-middle being from 0.1 mm to 15 mm.

The diameters of the melt-entry (D-in) apertures and melt-exit (D-out) apertures are defined via the dependencies described in relationships (1) and (2). The parameters have been defined on the basis of FIG. 1 a) and FIG. 1 b).

(1) D-out/D-in is from 0.0067 to 37.5, preferably from 0.05 to 4, particularly preferably from 0.1 to 2.
(2) D-out/D-middle is from 1.01 to 4, preferably from 1.3 to 2, particularly preferably from 1.4 to 1.7.

In one preferred embodiment (see FIG. 1 b)), there can be a cylindrical portion of length L-middle in the region of D-middle, in such a way that L-out/L-middle extends from 1.1 to 10.

Another feature of the dies of the invention in one preferred embodiment is the design of the flow channel in such a way that the inner walls of the inflow region or of the outflow region or of the inflow region and of the outflow region have a curvature in the direction of the longitudinal axis of the flow channel. The corresponding curvature radii “R-in” for the inflow region and “R-out” for the outflow region are shown in FIG. 1.

The curvature radii “R-in” and “R-out” of FIG. 1 are defined via the values (3) and (4):

(3) −level surface (conical bore): R=infinity]
(4) −[conical die with curved inflow or outflow: R>0]

The value of R-in is from 1 mm to ∞ (infinity), preferably from 5 mm to co, particularly preferably from 10 mm to ∞.

The value of R-out is from 10 mm to ∞ (infinity), preferably from 50 mm to ∞, particularly preferably from 200 mm to ∞.

The invention further provides a technical device which comprises a multiplicity of such dies, so that the emerging viscoelastic mass, preferably polymer melt, is divided here into a multiplicity of melt strands. Said technical device can have been installed by way of example at the end of a manifold such as that used by way of example in an extruder head or in underwater pelletization, with the aim of dividing the strands subsequently after cooling and solidification to give pellets. The technical device can moreover be used in apparatuses which use a manifold in order to increase the surface area of the strands, such as by way of example in a strand devolatilizer (see WO 01/39856 A1).

The invention further provides the use of a die of the invention or of a die plate for the melt-extrusion of viscoelastic masses, characterized in that the flow channel of the dies has a divergent melt-outflow region, the length L-out of which is greater than the length L-in in the convergent melt-inflow region and the ratio L-out/L-in is from 1.1 to 15, preferably from 2 to 10, particularly preferably from 4 to 8.

Those portions of the dies of the invention that come into contact with the product can be manufactured from any desired material. Said portions are preferably manufactured from steel or from a low-iron-content metal alloy. In one preferred embodiment, the dies are manufactured from a low-iron-content material having at most 10% by weight iron content. Particularly suitable alloys for all of the portions of the dies that come into contact with the product are those composed of less than 1% by weight of aluminum, less than 25% by weight of chromium, less than 8% by weight of iron, less than 4% by weight of cobalt, less than 6% by weight of tungsten, less than 4% by weight of manganese, less than 1% by weight of copper, and less than 1% by weight of titanium, less than 5% by weight of niobium, and also from 5 to 35% by weight of molybdenum and from 45 to 75% by weight of nickel. It is particularly preferable that all of those portions of the dies that come into contact with the product have been manufactured from Alloy 59 (2.4605), Inconell 686 (2.4606), Alloy-B2, Alloy B-3, Alloy B4, Alloy C-22, Alloy-C276, Alloy-C4, Alloy 625, 1.8550, 1.4112, 1.2379, 1.4122 or 1.4313.

In one specific embodiment, the dies of the invention can have a surface treatment on that inner side of the flow channel that comes into contact with the polymer melt. This can be an additional coating, e.g. with polymers (e.g. PTFE or other fluorinated hydrocarbons) or with metals or metal compounds (e.g. TiN, CrN) or with organic or inorganic substances (e.g. amorphous carbon (e.g. “diamond-like carbon”) or ceramic). It is furthermore possible, if necessary, to carry out additional optional reduction of the surface roughness, e.g. via polishing or electropolishing (also relined electrolytic polishing) or to increase the surface roughness (e.g. via sandblasting). Electropolishing is an electrochemical metal-treatment process in which the metal to be polished is inserted as anode within an electrical circuit, where the electrolyte is composed of an acid or of an acid mixture.

The dies of the invention as described are suitable for from 50 g/h to 100 000 g/h of polymer-melt throughput per die at temperatures of from 100° C. to 450° C. The dies can be heated dies.

The customary melt viscosities (zero viscosities) determined by way of shear-rheology measurements (see, for example, M. Pahl, W. Gleiβle, H.-M. Laun: Praktische Rheologie der Kunststoffe and Elastomere [Practical rheology of plastics and elastomers]) for the polymers used are from 20 Pa·s to 25 000 Pa·s at 300° C.

The extrusion process can therefore be carried out in any desired device in which exit of melt strands from a die is standard procedure. This type of device usually includes equipment for the melting of the polymer (except when molten polymer is fed to the device), and also equipment for pumping or forcing the molten polymer through the die apertures with a suitable velocity. Useful devices for the pumping process or the melting and pumping process are gear pumps, single-screw and twin-screw extruders, rams (as in a ram extruder) or a pressurized container (for example gas-pressurized) which comprises molten polymer. Extrusion conditions, e.g. the polymer temperature, can be those normally used for processes to extrude said polymer.

The invention further provides a die plate in which a multiplicity of individual dies of the invention have been arranged, and which is part of a (heatable) manifold. The location of this is, for example, after the melt-exit aperture of an extruder or after a melt pump, and it distributes or introduces the melt stream from the exit aperture of the extruder or after the melt pump into the individual dies. There may also be a larger apparatus that accommodates the manifold, e.g. a devolatilizer apparatus, specifically a strand devolatilizer (see WO 01/58984 A1 and WO 01/39856 A1).

In a die plate of this type, there are, depending on the size of the extruder or of the melt pump, from 1 to 500 000, preferably from 2 to 100 000, individual dies of the invention arranged in one or more series, preferably from 1 to 4 series. In one specific form, the die plate can also be round and the arrangement of the dies can be concentric in one or more series around a central point. There can moreover be one or more plates mutually juxtaposed or mutually superposed. In one preferred embodiment of the die plate, all of the dies of the invention are of the same size and have the same separation from one another, and also have the same geometric parameters. Appropriate internals within the manifold are used by way of example to conduct the melt from the central exit aperture to the die plate in such a way that all of the dies receive a supply of polymer melt at comparable pressure, thus ensuring uniform formation of polymer-melt strands over the entire length and width of the die plate.

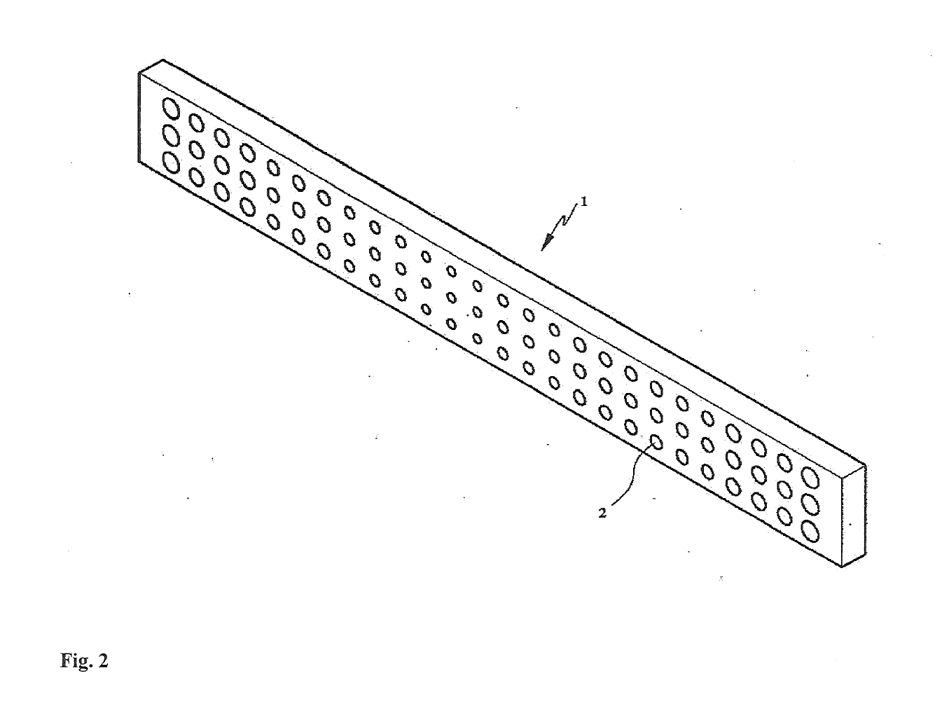

FIG. 2 shows by way of example one specific embodiment of this type of extrusion device with the die located therein.

The process of the invention uses the dies of the invention to extrude polymer melts to give polymer-melt strands, and thus reduces the risk of contamination of the melt strands by die deposits during a processing procedure which takes a number of hours. After exit from the die, the polymer-melt strands are usually cooled by water and, during or after solidification, pelletized by suitable processes. The dies of the invention can produce high-purity pellets which comply with the stringent purity requirements by way of example in relation to optical quality for the production of optical data carriers, such as CDs or DVDs, or for the production of, for example, optical waveguides, diffuser panels, optical lenses, foils, fibers, sheets and thin-walled moldings.

Die plates for the underwater pelletization of polymers have a plurality of exit apertures arranged on an annular cutting surface. Rotating blades cut the polymer strands shortly after the polymer has been extruded from the exit apertures. The dies of the invention inhibit build-up of hardened polymer in the exit aperture and therefore permit problem-free operation of the process.

Suitable materials for the extrusion of polymer-melt strands using the dies of the invention are any of the thermoplastic polymers, elastomers prior to the crosslinking process and thermosets prior to the crosslinking process. The dies of the invention are particularly suitable for the processing and treatment of polycarbonates, polyesters, polyethers, polyolefins, halogenated polyolefins, thermoplastic polyimides, poly(imide ethers) and polyamides. Said thermoplastics can take the form of pure materials or of mixtures with fillers and reinforcing materials, particular examples being glass fibers, or mixtures with one another or with other polymers or mixtures with customary polymer additives, e.g. colorants, processing aids, fillers, reinforcing materials, antioxidants, colorants, pigments, flame retardants or stabilizers. Examples of these are carbon black, glass fiber, clay, mica, talc, chalk, calcium carbonate, titanium dioxide, graphite fibers, carbon fibers and natural fibers.

FIG. 1) shows cross sections of the dies of the invention in which the parameters L-in, L-middle and L-out, D-in, D-middle and D-out, and also R-in and R-out have been shown. “FD” here indicates the direction of flow (flow direction).

FIG. 1b) is one preferred embodiment in which there is a cylindrical portion of length L-middle in the region of D-middle.

FIG. 2) shows an example of a die plate (1) on which the dies (2) have been mutually juxtaposed.

### EXAMPLES

Trials were carried out with the dies of the invention and standard dies as reference in a corotating twin-screw extruder, using the die measurements listed below.

### Example of Die of the Invention (Short Divergent Section):

### D-in=8.08 mm

### D-out=8.08 mm

### D-middle=5.08 mm

### L-in=7.48 mm

### L-out=14.52 mm

### R-in=18.96 mm

### R-out=66.2 mm

### Example of Die of the Invention (Long Divergent Section):

### D-in=8.08 mm

### D-out=8.08 mm

### D-middle=5.08 mm

### L-in=7.48 mm

### L-out=34.52 mm

### R-in=18.96 mm

### R-out=386 mm

### Standard Die (Cylindrical):

### D-in=8.08 mm

### D-out=5.08 mm

### D-middle=5.08 mm

### L-in=5.6 mm

### L-out=16.4 mm

### R-in=18.96 mm

R-out=infinity

### Example 1

### Trials with Polybutylene Terephthalate

Pocan® DP 7244 pellets (producer: Lanxess Deutschland GmbH) were conveyed in a corotating twin-screw extruder (ZSK 32Mc; producer: Coperion Werner & Pfleiderer), and melted in the extruder, and the melt was forced through a die plate installed at the end of the extruder. The die plate comprised four dies, of which respectively one inner and one outer die had cylindrical standard geometry. Said dies served as reference. The two other dies had been manufactured in such a way as to permit installation of interchangeable die inserts; the “short divergent section” dies were used for trial 1, and the “long divergent section” dies were used for trial 2.

A camera was used to observe and record the strands emerging from the dies. The time from the start of the extrusion process to the juncture at which deposits occurred on the dies was also measured. A thermometer probe was used to measure the melt temperature in the strands; it was identical in all of the strands.

The throughput per die was 26.25 kg·h⁻¹, the extruder rotation rate was 255 min⁻¹ and the melt temperature was 285° C.

With the standard die, severe die drool is observed 30 s after start. In contrast, when the optimized “short divergent section” die geometry is used, all that is observed is slight die drool after about 1 min, and when the “long divergent section” die geometry is used no die drool is observed even over a relatively long operating time.

### Example 2

### Trials with Polycarbonate

Makrolon® DP1-1265 pellets (producer: Bayer MaterialScience AG) were conveyed in a corotating twin-screw extruder (ZSK 32Mc; producer: Coperion Werner & Pfleiderer), and melted in the extruder, and the melt was forced through a die plate installed at the end of the extruder. The die plate comprised four dies, of which respectively one inner and one outer die had cylindrical standard geometry. Said dies served as reference. The two other dies had been manufactured in such a way as to permit installation of interchangeable die inserts. The “long divergent section” dies were secured in said die inserts.

A camera was used to observe and record the strands emerging from the dies. The time from the start of the extrusion process to the juncture at which deposits occurred or droplets formed on the dies was also measured. A thermometer probe was used to measure the melt temperature in the strands; it was identical in all of the strands.

The throughput per die in the first trial was 25 kg·h⁻¹, the extruder rotation rate was 600 min⁻¹ and the melt temperature was 302° C.

With the standard die, slight droplet formation was observed 45 min after start. With the optimized “long divergent section” die geometry, in contrast, no droplet formation occurs.

In a second trial, the throughput was reduced to 21.25 kg h⁻¹ and the melt temperature was increased to 314° C. The extruder rotation rate was kept constant at 600 min⁻¹.

With the standard die, droplet formation is likewise observed, and after 3 h of trial time, melt film completely covered the die plate below the die. In contrast, with the optimized “long divergent section” die geometry, no droplet formation occurred after a number of hours of operating time, despite reduced viscosity.

### Example 3

### Long-Term Trials with Polycarbonate

Makrolon® DP1-1265 pellets (producer: Bayer MaterialScience AG) were conveyed in a corotating twin-screw extruder (ZSK 32Mc; producer: Coperion Werner & Pfleiderer), and melted in the extruder, and the melt was forced through a die plate installed at the end of the extruder. The die plate comprised four dies, of which respectively one inner and one outer die had cylindrical standard geometry. Said dies served as reference. The two other dies had been manufactured in such a way as to permit installation of interchangeable die inserts. The “long divergent section” dies were secured in said die inserts.

A camera was used to observe and record the strands emerging from the dies, and these were recorded on video. The time required for deposits to occur at the dies was also measured. A thermometer probe was used to measure the melt temperature in the strands; it was identical in all of the strands.

The throughput per die was 25 kg·h⁻¹, the rotation rate was 600 min⁻¹ and the melt temperature was 314° C.

With the standard die, droplet formation is observed 45 min after start. After 3 h of trial time, melt film had completely covered the die plate below the die. In contrast, with the optimized “long divergent section” die geometry, no droplet formation occurred even after 9 h of operating time.

The examples show that, within the trial time studied, both in the case of polycarbonate and in the case of glass-fiber-reinforced polyester, the dies of the invention surprisingly, unlike dies of the prior art, substantially reduce the extent of deposits or eliminate deposits entirely.

Surprisingly, in the case of the glass-fiber-reinforced polyester studied, no die drool was observed on the dies of the invention; this can be discerned from the examples of the invention. Surprisingly, the “long divergent section” dies in particular exhibited a particularly good effect.

Surprisingly, in the case of the polycarbonate melt studied, which has very low viscosity, no droplet formation was observed at the die; this can be seen from the examples of the invention.

1.-14. (canceled)

15. A die for the melt-extrusion of viscoelastic masses, the die comprising a flow channel having a divergent melt-outflow region, wherein the length, L-out, of which is greater than the length, L-in, of a convergent melt-inflow region, and the ratio L-out/L-in is from 1.1 to 15.

16. The die as claimed in claim 15, wherein diameters of melt-entry and melt-exit apertures have a ratio of D-out/D-in from 0.05 to 4 and a ratio of D-out/D-middle from 1.01 to 4.

17. The die as claimed in claim 16, wherein L-out is from 2 mm to 100 mm, D-out is from 0.2 mm to 15 mm, L-in is from 0.13 mm to 200 mm, D-in is from 0.4 mm to 30 mm and D-middle is from 0.1 mm to 15 mm.

18. The die as claimed in claim 15, wherein inner walls of at least one of the inflow region and the outflow region have curvature radii R-in and R-out in the direction of a longitudinal axis of the flow channel.

19. The die as claimed in claim 18, wherein the curvature radii have the following values: R-in from 1 mm to ∞ (infinity) and R-out from 10 mm to ∞ (infinity).

20. The die as claimed in claim 18, wherein the curvature radii have the following values: R-in from 5 mm to ∞ and R-out from 100 mm to ∞.

21. A die plate, comprising a plurality of dies as claimed in claim 15, the dies being mutually juxtaposed, mutually superposed, or arranged concentrically in one or more series.

22. A process for the extrusion of a polymer melt to give polymer-melt strands, comprising extruding the polymer melt using a die as claimed in claim.

23. The process as claimed in claim 22, wherein the polymer strands are cooled by a liquid or by a gas after exit from the dies.

24. The process as claimed in claim 22, wherein the polymer strands are pelletized after leaving the dies.

25. The process as claimed in claim 22, wherein the polymer melt comprises thermoplastic polymers, elastomers prior to the crosslinking process or thermosets prior to the crosslinking process or a mixture thereof.

26. The process as claimed in claim 25, wherein the polymer melt comprises polycarbonates, polyesters, polyethers, polyolefins, halogenated polyolefins, thermoplastic polyimides, poly(imide ethers) or polyamides or a mixture thereof.

27. The process as claimed in claim 22, wherein fillers or reinforcing materials or polymer additives or organic or inorganic pigments, or a mixture thereof, are added to the polymer melt prior to extrusion.

28. An apparatus for the melt-extrusion of viscoelastic masses, comprising one or more dies as claimed in claim 15 and equipment for the expulsion of the viscoelastic mass through the dies.
